(19) United States
(12) Patent Application Publication
(10) Pub. No.: US 2006/0089121 A1
(43) Pub. Date: Apr. 27, 2006

(54) Method and apparatus for automatic connecting of virtual private network clients to a network

(76) Inventors: Hani Elgebaly, Beaverton, OR (US); Mike B. Andrews, Beaverton, OR (US); Ranjit S. Narjala, Hillsboro, OR (US); Liu Changwen, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/974,175

(22) Filed: Oct. 27, 2004

(51) Int. Cl. H04M 3/16

(52) U.S. Cl. 455/410; 455/445

(57) ABSTRACT

A device is disclosed. The device includes a virtual private network (VPN) to automatically retrieve user VPN credentials and to automatically establish a VPN using the credentials whenever a network connection is established to a network access point.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF THE INVENTION

The present invention relates to networks; more particularly, the present invention relates to connecting to a network.

### BACKGROUND

Virtual private networks (VPNs) enable the use of a public telecommunication infrastructure, such as the Internet, to provide remote offices or individual users with secure access to an organizational network. VPN applications are often implemented on wireless computing devices (e.g., notebook computers, PDAs, smart phones, etc.).

When a device roams between wireless access points, or between different network media types (e.g., wired LAN, wireless LAN, wireless WAN), it is likely that resultant subnet changes or the encountering of network dead spots will result in intermittent loss and subsequent re-establishment of network connectivity. If a VPN client is employed on the device to protect network traffic, the user is typically required to manually enter authentication information (e.g. a PIN or password) each time that network connectivity is re-gained.

### BRIEF DESCRIPTION OF THE DRAWINGS

The invention is illustrated by way of example and not limitation in the figures of the accompanying drawings, in which like references indicate similar elements, and in which:

FIG. 1 illustrates one embodiment of a network;

FIG. 2 illustrates a flow diagram for one embodiment of reconnecting a VPN; and

FIG. 3 illustrates a block diagram of one embodiment of a system.

### DETAILED DESCRIPTION

According to one embodiment, a method for automatically connecting a VPN client is described. In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art.

An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

The instructions of the programming language(s) may be executed by one or more processing devices (e.g., processors, controllers, control processing units (CPUs), execution cores, etc.).

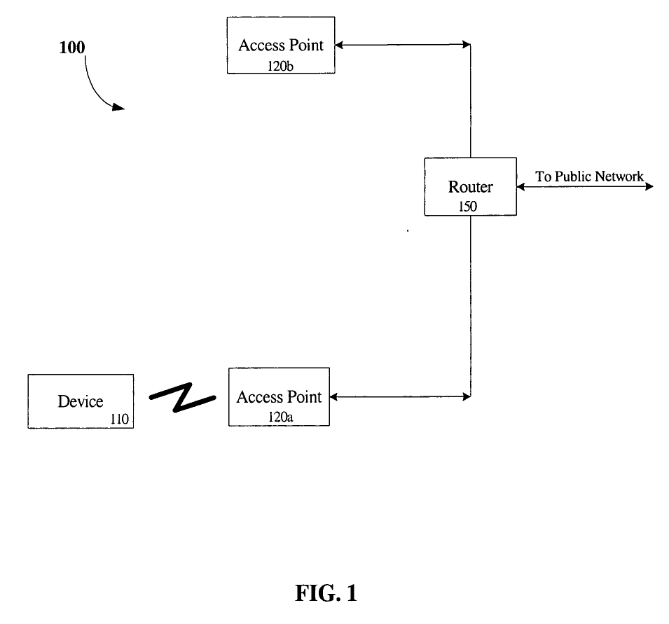

FIG. 1 illustrates one embodiment of a network 100. Network 100 includes a device 110, access points 120a and 120b and router 150. According to one embodiment, device 110 is a wireless device that is capable of accessing network 100 via a wireless communications link. In one embodiment, device 110 is a notebook computer. However, in other embodiments device 110 may be implemented using a personal digital assistant (PDA), Smart Phone, etc.

Access points 120 may be wireless access points that enables device 110 to access network 100. In such an embodiment, access points 120 conform to IEEE 802.11b and/or IEEE 802.11g standards. However, other wireless network interfaces and/or protocols can also be supported.

Router 150 couples network 100 to an external network, such as the public Internet, and forwards data packets between networks. According to one embodiment, device 110 is a VPN client that enables device 110 to communicate with one or more servers (not shown) on an organizational network via a VPN tunnel. Thus, secure data transactions may occur between device 100 on network 100 and servers at an organizational network via a public network.

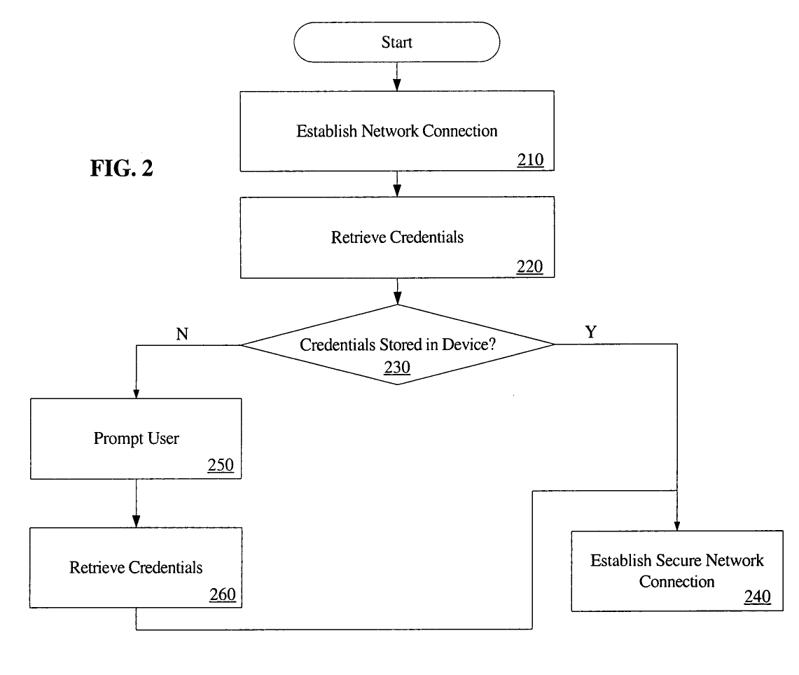

According to one embodiment, device 110 operating as a VPN client automatically attempts to retrieve cached VPN credentials in order to automatically establish a VPN tunnel whenever network connectivity is established. FIG. 2 illustrates a flow diagram of one embodiment for automatically re-establishing a VPN tunnel. At processing block 210, a connection to an access point (e.g., 110) is established.

At processing block 220, a VPN client retrieves user credentials (e.g., a PIN or username/password) to determine whether the user is authorized to access the server. At decision block 230, it is determined whether the credentials are stored in a secure storage device, such as a CAPI-enabled Crypto Service Provider device (e.g. a Trusted Platform Module (TPM)).

If the user credentials are cached in the secure storage device, the VPN client automatically establishes a VPN tunnel without prompting the user, processing block 240. However, if no user credentials are cached in the secure storage device, the VPN client will prompt the user for the credentials, processing block 250.

Note that credentials stored in the secure device are erased following a system reboot. Thus, a user is to re-enter credentials following a system boot. In a further embodiment, the cache may be flushed due to a timeout. In such an embodiment, cached credentials are not to be accessible by any entity after a predetermined timeout period specified by an IT administrator. Thus, the credentials are flushed from the secure storage device or locked by the secure storage, unless the credentials are renewed by user authentication before the timeout expires.

At processing block 260, the credentials are received from the user. Once the user credentials are authenticated, the user's VPN credentials are stored at the secure device. Subsequently, at processing block 240 the VPN tunnel is established.

The above method enables automatic re-establishment of a VPN after a network connection has been lost. For example, the network connection may be terminated due to a dead spot or device 100 being moved out of range from access point 110a. After a connection to network 100 is re-established (e.g., device 110 having been moved from an area serviced by access point 110a to within range of access point 110b), the VPN client will automatically attempt to retrieve the user credentials previously cached in the secure storage device and automatically establish a VPN tunnel. In addition, the method enables Personal Information Managers (e.g., email or calendar clients) to remain connected and synchronized as the user moves around the network, without the need for user intervention.

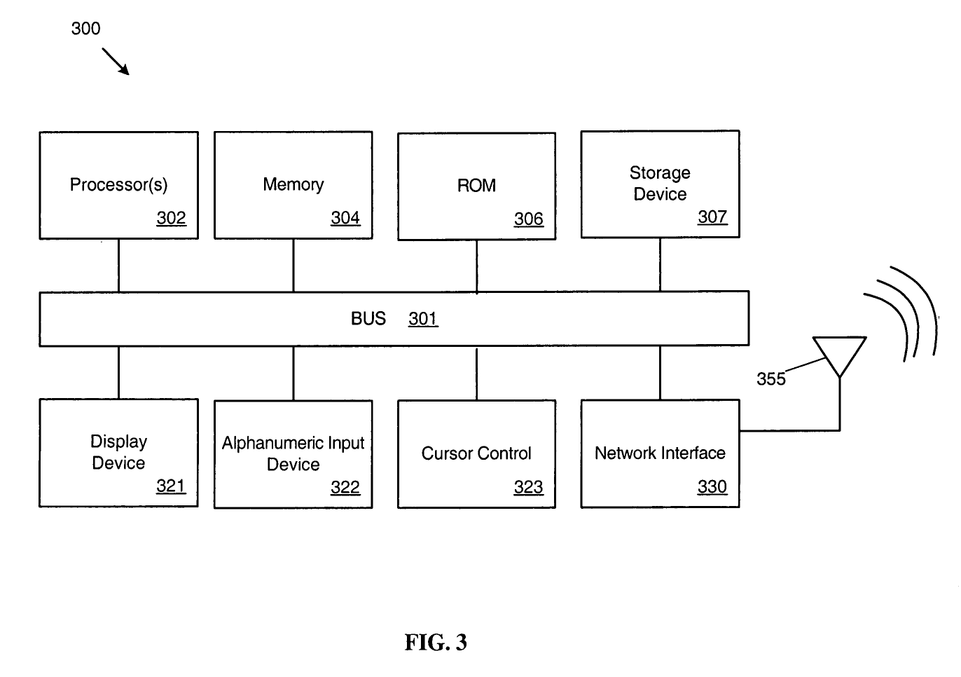

FIG. 3 is a block diagram of one embodiment of an electronic system 300. The electronic system 300 illustrated in FIG. 3 is intended to represent handheld device. As discussed above, device 100 may represent a range of electronic systems including, for example, desktop computer systems, laptop computer systems, cellular telephones, personal digital assistants (PDAs) including cellular-enabled PDAs, set top boxes. Alternative computer systems can include more, fewer and/or different components.

Electronic system 300 includes bus 301 or other communication device to communicate information, and processor 302 coupled to bus 301 that may process information. While electronic system 300 is illustrated with a single processor, electronic system 300 may include multiple processors and/or co-processors. Electronic system 300 further may include random access memory (RAM) or other dynamic storage device 304 (referred to as main memory), coupled to bus 301 and may store information and instructions that may be executed by processor 302. Main memory 304 may also be used to store temporary variables or other intermediate information during execution of instructions by processor 302.

Electronic system 300 may also include read only memory (ROM) and/or other static storage device 306 coupled to bus 301 that may store static information and instructions for processor 302. Data storage device 307 may be coupled to bus 301 to store information and instructions. Data storage device 307 such as a magnetic disk or optical disc and corresponding drive may be coupled to electronic system 300.

Electronic system 300 may also be coupled via bus 301 to display device 321, such as a cathode ray tube (CRT) or liquid crystal display (LCD), to display information to a user. Alphanumeric input device 322, including alphanumeric and other keys, may be coupled to bus 301 to communicate information and command selections to processor 302. Another type of user input device is cursor control 323, such as a mouse, a trackball, or cursor direction keys to communicate direction information and command selections to processor 302 and to control cursor movement on display 321. Electronic system 300 further may include network interface(s) 330 to provide access to a network, such as a local area network. Network interface(s) 330 may include, for example, a wireless network interface having antenna 355, which may represent one or more antenna(e). Antenna 355 may be a deployable antenna that is part of a removable card as described herein.

In one embodiment, network interface(s) 330 may provide access to a local area network, for example, by conforming to IEEE 802.11b and/or IEEE 802.11g standards, and/or the wireless network interface may provide access to a personal area network, for example, by conforming to Bluetooth standards. Other wireless network interfaces and/or protocols can also be supported.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

In addition to, or instead of, communication via wireless LAN standards, network interface(s) 330 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A method comprising:
establishing a network connection at to a network access point;
a virtual private network (VPN) client determining whether user VPN credentials are stored in a storage device; and
automatically establishing a VPN tunnel using the VPN credentials if the VPN credentials are stored in the storage device.

2. The method of claim 1 further comprising retrieving the VPN credentials if stored in the storage device.

3. The method of claim 1 further comprising:
prompting a user to enter the VPN credentials if the VPN credentials are not stored in the storage device;
receiving the VPN credentials from the user; and
establishing the VPN tunnel.

4. The method of claim 1 further comprising terminating the network connection.

5. The method of claim 4 wherein the network connection is terminated due to moving out of range from the network access point.

6. The method of claim 4 further comprising:
re-establishing a second network connection at to the network access point;
retrieving the VPN credentials from the storage device; and
automatically establishing a second VPN tunnel using the VPN credentials.

7. The method of claim 4 further comprising:
establishing a second network connection at to a second network access point;
retrieving the VPN credentials from the storage device; and
automatically establishing a second VPN tunnel using the VPN credentials.

8. A device comprising a virtual private network (VPN) to automatically retrieve user VPN credentials and to automatically establish a VPN using the credentials whenever a network connection is established to a network access point.

9. The device of claim 8 further comprising a storage device to store the VPN credentials.

10. The device of claim 9 further wherein the VPN client retrieves the VPN credentials from the storage device whenever the network connection is established.

11. The device of claim 9 further wherein the storage device is a secure storage device.

12. The device of claim 9 further comprising:
a processor;
a network interface to establish the network connection; and
an antenna communicatively coupled to the network access point.

13. An article of manufacture including one or more computer readable media that embody a program of instructions, wherein the program of instructions, when executed by a processing unit, causes the processing unit:
establish a network connection at to a network access point;
determine whether user VPN credentials are stored in a storage device; and
automatically establish a VPN tunnel using the VPN credentials if the VPN credentials are stored in the storage device.

14. The article of manufacture of claim 13 wherein the program of instructions, when executed by a processing unit, further causes the processing unit to retrieve the VPN credentials if stored in the storage device.

15. The article of manufacture of claim 13 wherein the program of instructions, when executed by a processing unit, further causes the processing unit to:
prompt a user to enter the VPN credentials if the VPN credentials are not stored in the storage device;
receive the VPN credentials from the user; and
establish the VPN tunnel.

16. The article of manufacture of claim 13 wherein the program of instructions, when executed by a processing unit, further causes the processing unit to terminating the network connection.

17. The article of manufacture of claim 16 wherein the program of instructions, when executed by a processing unit, further causes the processing unit to:
re-establish a second network connection at to the network access point;
retrieve the VPN credentials from the storage device; and
automatically establish a second VPN tunnel using the VPN credentials.

18. The article of manufacture of claim 16 wherein the program of instructions, when executed by a processing unit, further causes the processing unit to:
establish a second network connection at to a second network access point;
retrieve the VPN credentials from the storage device; and
automatically establish a second VPN tunnel using the VPN credentials.

19. A network comprising:
a first wireless network access point;
a second wireless network access point; and
wireless device comprising a virtual private network (VPN) to automatically retrieve user VPN credentials and automatically establish a VPN using the credentials whenever a network connection is terminated at the first network access point and a subsequent network connection is established at the second network access point.

20. The network of claim 19 wherein the wireless device further comprises a storage device to store the VPN credentials.

21. The network of claim 19 further comprising a router coupled to the first network access point and the second network access point.
